(19) United States
(12) Patent Application Publication
(10) Pub. No.: US 2011/0265732 A1
(43) Pub. Date: Nov. 3, 2011

(54) Pet chew toy

(76) Inventor: Chih-Cheng Lai, Taipei (TW)

(21) Appl. No.: 12/799,703

(22) Filed: Apr. 30, 2010

(51) Int. Cl. A01K 29/00

(52) U.S. Cl. 119/710; 119/709

(57) ABSTRACT

A pet chew toy has a shell and a filling. The shell is solid, chewable and edible, and defines a chamber in the shell. The filling is edible, corresponds to and is mounted in the chamber. The chamber may be fully formed in the shell, may be formed longitudinally through the shell and may further comprise branches formed transversely through the shell. The filling may be meat based. Therefore, pets are encouraged to chew the chew toy to access the filling.

### BACKGROUND OF THE INVENTION

1. Field of the Invention

The present invention is related to a pet chew toy, and more particularly to a pet chew toy having an edible portion sheathed by an edible, solid and chewable portion.

2. Description of the Related Art

For dental hygiene and encouraging play, pets are given chew toys. Dog chews toys may take many forms, such as sticks, twisted sticks, braided sticks, hollow pipes, shoes, rolls, bones and the like, and are primarily targeted at delivering long-lasting chewing pleasure to dogs.

Despite various forms designed to attract dogs, most dog chews currently available are made of a single material, such as rawhide, chicken, beef, spinach and the like. Therefore, dogs get bored due to lack of stimulation. Therefore, a longer lasting and more interesting dog chew is developed.

### SUMMARY OF THE INVENTION

An objective of the present invention is to provide a pet chew toy having an edible portion sheathed by an edible, solid and chewable portion.

To achieve the foregoing objective, the pet chew toy has a shell and a filling. The shell is formed from a solid, chewable and edible material and defining a chamber inside the shell. The filling corresponds to and is mounted in the chamber.

As the pet food of the present invention is divided into two portions, two flavors are provided. The inaccessibility of the filling urges the desire of pets to keep chewing the pet food. Hence, the pet food of the present invention addresses more flavors and chewing pleasure to pets.

### BRIEF DESCRIPTION OF THE DRAWINGS

FIG. 1 is a perspective view of a first preferred embodiment of a pet chew toy in accordance with the present invention;

FIG. 2 is a cross-sectional view of the pet chew toy in FIG. 1;

FIG. 3 is a perspective view of a second preferred embodiment of a pet chew toy in accordance with the present invention;

FIG. 4 is a cross-sectional view of the pet chew toy in FIG. 3;

FIG. 5 is a perspective view of a third preferred embodiment of a pet chew toy in accordance with the present invention; and

FIG. 6 is a cross-sectional view of the pet chew toy in FIG. 5.

### DETAILED DESCRIPTION OF THE INVENTION

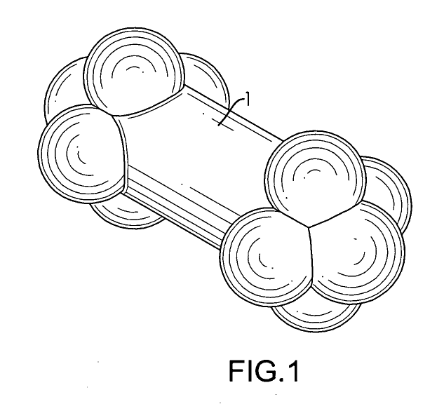

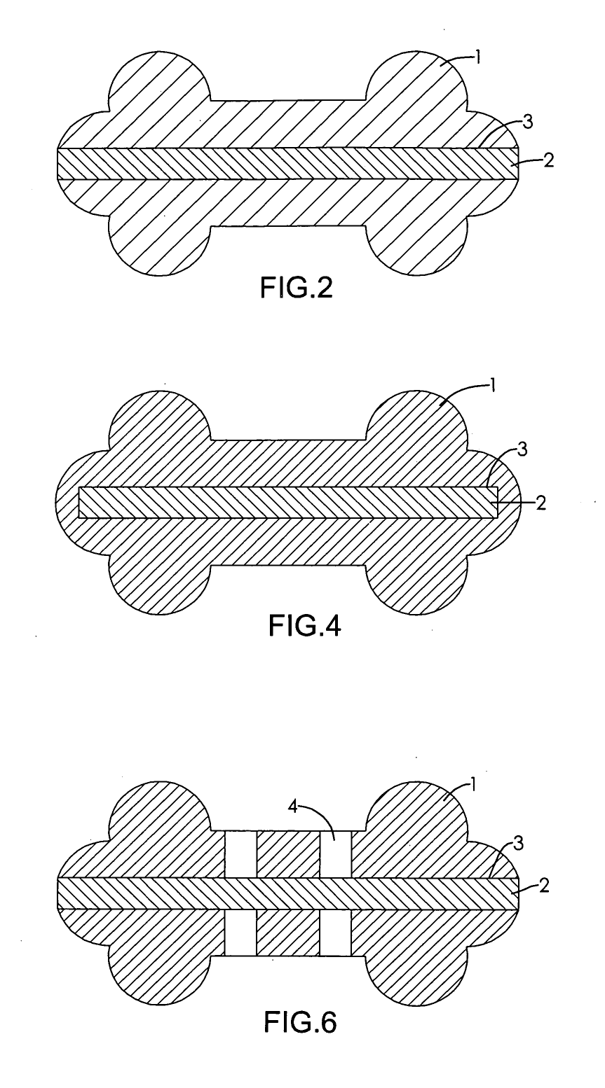

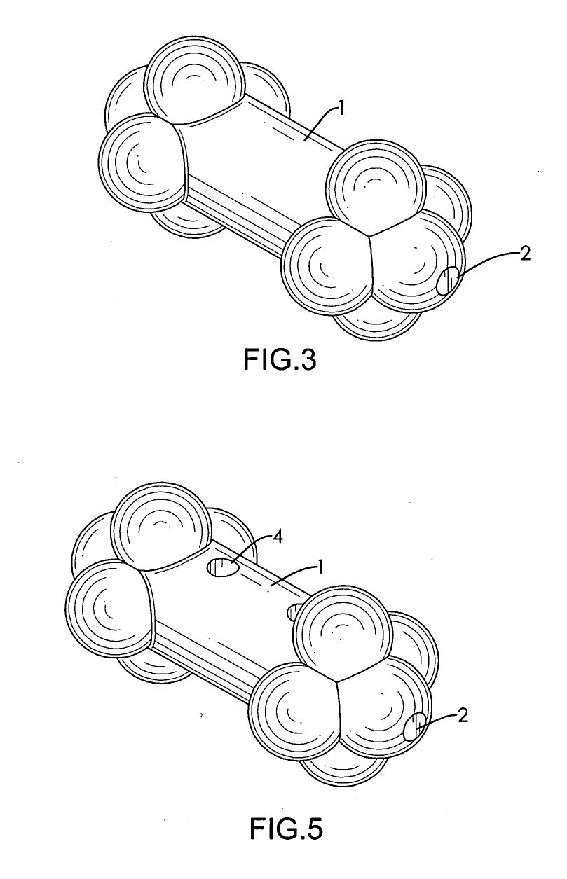

With reference to FIGS. 1 and 2, a pet chew toy in accordance with the present invention has a shell (1) and a filling (2). The shell (1) is solid, chewable and edible and defines a chamber (3) in the shell (1). The shell (1) may take a form of a shape to attract attention of pets such as a bone, shoe, or the like. The filling (2) is edible corresponds to and is mounted in the chamber (3). The chamber (3) may be fully formed in the shell (1). With further reference to FIGS. 3 and 4, the chamber (3) is formed longitudinally through the shell (1).

With reference to FIGS. 5 and 6, the chamber (3) may be formed longitudinally through the shell (1) and further has at least one branch chamber (4) formed transversely through the shell (1).

For all the aforementioned embodiments, the filling (2) may be made of chicken, beef, rawhide or the like; the shell (1) may be made of corn flour or the like.

Differing from conventional chewable pet chew toy, the pet chew toy of the present invention has two different edible portions and thus two different flavors. The filling (2) of the pet chew toy is preferred to be a meat portion. Since pets are generally carnivorous, meat flavor hidden inside the pet chew toy stimulates and encourages chewing of the pet chew toy. The more the filling (2) is inaccessible, the more pets are eager to chew the pet chew toy. Depending on the extent of accessibility of the filling (2) embedded inside, different embodiments of the present invention allow pets to enjoy different degrees of chewing pleasure. As the shell (1) is hard enough, the pet chew toy can be repeatedly chewed without being easily penetrated or fractured by biting. Accordingly, the pet chew toy of the present invention stimulates and encourages pets to chew for greater enjoyment and to provide dental care.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A pet chew toy, comprising:
a shell formed from a solid, chewable and edible material and defining a chamber inside the shell; and
a filling corresponding to and mounted in the chamber.

2. The pet chew toy as claimed in claim 1, wherein the chamber is fully formed in the shell.

3. The pet chew toy as claimed in claim 1, wherein the chamber is formed longitudinally through the shell.

4. The pet chew toy as claimed in claim 1, wherein the chamber is formed longitudinally through the shell and further has at least one branch chamber formed transversely through the shell.

5. The pet chew toy as claimed in claim 1, wherein the filling is made of chicken.

6. The pet chew toy as claimed in claim 2, wherein the filling is made of chicken.

7. The pet chew toy as claimed in claim 3, wherein the filling is made of chicken.

8. The pet chew toy as claimed in claim 4, wherein the filling is made of chicken.

9. The pet chew toy as claimed in claim 1, wherein the filling is made of beef.

10. The pet chew toy as claimed in claim 2, wherein the filling is made of beef.

11. The pet chew toy as claimed in claim 3, wherein the filling is made of beef.

12. The pet chew toy as claimed in claim 4, wherein the filling is made of beef

13. The pet chew toy as claimed in claim 1, wherein the filling is made of rawhide.

14. The pet chew toy as claimed in claim 2, wherein the filling is made of rawhide.

15. The pet chew toy as claimed in claim 3, wherein the filling is made of rawhide.

16. The pet chew toy as claimed in claim 4, wherein the filling is made of rawhide.

17. The pet chew toy as claimed in claim 1, wherein the shell is made of corn flour.

18. The pet chew toy as claimed in claim 2, wherein the shell is made of corn flour.

19. The pet chew toy as claimed in claim 3, wherein the shell is made of corn flour.

20. The pet chew toy as claimed in claim 4, wherein the shell is made of corn flour.
